(19) United States
(12) Patent Application Publication
(10) Pub. No.: US 2020/0002109 A1
(43) Pub. Date: Jan. 2, 2020

(54) RUBBER COMPOSITION AND PAPER FEEDING ROLLER FORMED OF THE SAME

(71) Applicant: SUMITOMO RUBBER INDUSTRIES, LTD., Hyogo (JP)

(72) Inventors: MASASHI HAMAKUBO, Hyogo (JP); TOSHIYUKI HIRAI, Hyogo (JP); YOSHIHIRO YAMADA, Hyogo (JP)

(73) Assignee: SUMITOMO RUBBER INDUSTRIES, LTD., HYOGO (JP)

(21) Appl. No.: 16/367,254

(22) Filed: Mar. 28, 2019

(30) Foreign Application Priority Data
Jun. 29, 2018 (JP) 2018-124757

(51) Int. Cl. B65H 3/06; C08K 3/36; C08L 23/16; C08K 3/013; B65H 3/52

(52) U.S. Cl. CPC B65H 3/0638; C08K 3/36; C08L 23/16; C08K 3/013; C08L 2312/00; B65H 2519/00; B65H 2401/111; B65H 2401/2311; B65H 2404/10; B65H 3/5284

(57) ABSTRACT

Provided are a rubber composition capable of imparting a high tensile strength to a roller main body so as to be able to be used for equipment that allows paper to pass through at high speed, while maintaining high abrasion resistance of the roller main body and a favorable paper feeding performance of the paper feeding roller; and a paper feeding roller. There is provided a rubber composition contains: a rubber that includes a non-oil extended EPDM having an ethylene content of 55 to 72%; and more than 20 parts by mass and 30 parts by mass or less of a filler, and 2.5 parts by mass or more of a peroxide crosslinking agent per 100 parts by mass of the rubber, in which the filler contains 15 to 30 parts by mass of an amorphous silica per 100 parts by mass of the rubber.

### CROSS-REFERENCE TO RELATED APPLICATION

This application claims the priority benefit of Japanese Application Serial No. 2018-124757, filed on Jun. 29, 2018. The entirety of the above-mentioned patent applications is hereby incorporated by reference herein and made a part of this specification.

### BACKGROUND

### Technical Field

The present disclosure relates to a rubber composition, and a paper feeding roller that includes a roller main body formed by using the rubber composition.

### Description of Related Art

For example, a paper feeding roller is used for carrying (passing) sheets such as paper and plastic film, in various equipment such as an image forming apparatus such as a laser printer using electrophotography, an inkjet printer, an image scanner, or an automated teller machine (ATM).

Examples of the paper feeding roller include a paper supply roller, a carrying roller, a platen roller, a paper discharging roller, and the like, which rotate while coming into contact with the sheet so as to allow the sheet to pass through by friction.

The paper feeding roller is generally made of an elastic body such as rubber or soft resin, and is configured such that a shaft made of metal or the like is inserted through a through hole of a roller main body having a through hole through which the shaft is inserted, and the shaft is fixed thereto.

The roller main body is further required to have, for example, excellent ozone resistance, weather fastness, and the like for being used in image forming apparatuses, or to have excellent weather fastness, heat aging resistance, cold resistance, low-temperature characteristics, and the like in order to exhibit stable performance in an ATM installed in various places.

For this reason, a paper feeding roller in which the roller main body is formed by using ethylene propylene diene rubber (EPDM) which is excellent in terms of these characteristics, has become widespread.

For example, in a paper feeding roller used for equipment such as a high-speed image scanner, which allows a sheet to pass through at a high speed such as a sheet passing speed of 200 sheets/minute or more, because a load applied to the roller main body is large, the tensile strength of the roller body needs to become high, and therefore it is required that breakage does not occur during use.

In order to increase the tensile strength of the roller main body, increasing a proportion of a filler may be considered.

However, when increasing a proportion of filler, the abrasion resistance of the roller main body decreases, rubber hardness increases and thus flexibility decreases, and a frictional coefficient with respect to a sheet decreases, and therefore the paper feeding performance of the paper feeding roller may deteriorate.

An amorphous silica is known to have a high reinforcing effect (refer to Patent Document 1 (Japanese Patent Laid-Open No. 2016-65197) and Patent Document 2 (Japanese Patent Laid-Open No. 2016-222829), and the like).

For this reason, it can be conceived that, by using a small blending amount of an amorphous silica as a filler, it is possible to increase a tensile strength of the roller main body than had been the case, while curbing a decrease in abrasion resistance of the roller main body and a deterioration in a paper feeding performance of the paper feeding roller.

However, the tensile strengths of the roller main bodies in the examples of Patent Document 1 and 2 are all less than 10 MPa, which is a tensile strength insufficient for a paper feeding roller used in equipment such as a high-speed image scanner as described above, and therefore further improvement is required.

In addition, in Example 5 of Patent Document 2, the tensile strength of the roller main body is 10 MPa or more.

However, because of the above-mentioned condition in Example 5, a large amount of calcium carbonate is used in combination with an amorphous silica as a filler, and therefore it is not possible to avoid a decrease in abrasion resistance of the roller main body and a deterioration in a paper feeding performance of the paper feeding roller as described above.

The disclosure provides a rubber composition capable of imparting a high tensile strength to a roller main body so as to be able to be used specifically for equipment that allows paper to pass through at high speed, while maintaining high abrasion resistance of the roller main body and a favorable paper feeding performance of the paper feeding roller.

The disclosure provides a paper feeding roller in which a roller main body is formed using the above-mentioned rubber composition.

### SUMMARY

According to an embodiment, there is provided a rubber composition for forming a roller main body of a paper feeding roller, the rubber composition containing: a rubber that includes at least EPDMs; more than 20 parts by mass and 30 parts by mass or less of a filler per 100 parts by mass of a total amount of the rubber; and 2.5 parts by mass or more of a peroxide crosslinking agent per 100 parts by mass of the total amount of the rubber, in which the EPDMs include at least a non-oil extended EPDM having an ethylene content of 55% or more and 72% or less, and the filler contains at least 15 parts by mass or more and 30 parts by mass less of an amorphous silica per 100 parts by mass of the total amount of the rubber.

According to another embodiment, there is provided a paper feeding roller that includes a roller main body made of this rubber composition.

### BRIEF DESCRIPTION OF THE DRAWINGS

FIG. 1 is an enlarged perspective view showing a part of a paper feeding roller of the present disclosure, which is an example of an embodiment.

FIG. 2 is a view for explaining a method of measuring a frictional coefficient of a paper feeding roller in order to evaluate a paper feeding performance of the paper feeding roller formed by using a rubber composition of an example and a comparative example of the present disclosure.

### DESCRIPTION OF THE EMBODIMENTS

According to the present disclosure, it is possible to provide a rubber composition capable of imparting a high tensile strength to a roller main body so as to be able to be used specifically for equipment that allows paper to pass through at high speed, while maintaining high abrasion resistance of the roller main body and a favorable paper feeding performance of the paper feeding roller.

According to the present disclosure, it is possible to further provide a paper feeding roller in which a roller main body is formed using the above-mentioned rubber composition.

<<Rubber Composition>>

As described above, a rubber composition of the present disclosure contains: a rubber that includes at least EPDMs; more than 20 parts by mass and 30 parts by mass or less of a filler per 100 parts by mass of a total amount of the rubber; and 2.5 parts by mass or more of a peroxide crosslinking agent per 100 parts by mass of the total amount of the rubber, in which the EPDMs include at least a non-oil extended EPDM having an ethylene content of 55% or more and 72% or less, and the filler contains at least 15 parts by mass or more and 30 parts by mass less of an amorphous silica per 100 parts by mass of the total amount of the rubber.

According to the rubber composition of the present disclosure, by blending in each component at a predetermined proportion, it is possible to impart a high tensile strength to a roller main body so as to be used for equipment that allows paper to pass through at high speed as described above, while maintaining high abrasion resistance of the roller main body and a favorable paper feeding performance of the paper feeding roller.

This can also be clearly understood based on the results of examples and comparative examples to be described later.

<Rubber>

As s rubber, a rubber including at least EPDMs is used as described above.

In addition, as EPDMs, a non-oil extended EPDM having an ethylene content within the above-mentioned range is at least used among various EPDMs into which double bonds are introduced by adding a small amount of a third component (diene) to ethylene and propylene.

Examples of dienes include ethylidene norbornene (ENB), dicyclopentadiene (DCPD), and the like.

(Non-Oil Extended EPDM)

The reason why an ethylene content of the non-oil extended EPDM is limited to 55% or more and 72% or less is as follows.

That is, when a non-oil extended EPDM having an ethylene content of less than this range is used, it may not be possible to impart the aforementioned high tensile strength to the roller main body.

On the other hand, when a non-oil extended EPDM having an ethylene content exceeding the above-mentioned range is used, a viscosity of the rubber composition before crosslinking at the time of heating and melting increases, and therefore workability of the rubber composition deteriorates.

In addition, there is a problem that it is difficult to prepare a rubber composition by blending in each of the above-mentioned components, or to produce a roller main body by molding the prepared rubber composition into, for example, a cylindrical shape.

On the other hand, by selecting and using a non-oil extended EPDM having an ethylene content within the above-mentioned range, it is possible impart a high tensile strength to the roller main body while maintaining favorable workability of the rubber composition.

Specific examples of non-oil extended EPDMs having an ethylene content within the above-mentioned range are not limited thereto, and for example, it is possible to use one or two or more of the various non-oil extended EPDMs described below.

ESPRENE (registered trademark) (manufactured by Sumitomo Chemical Co., Ltd.) Series 301 [ethylene content: 62%, diene content: 3.0%], 502 [ethylene content: 56%, diene content: 4.0%], 512F [ethylene content: 65%, diene content: 4.0%], 552 [ethylene content: 55%, diene content: 4.0%], 553 [ethylene content: 58%, diene content: 4.5%], and 586 [ethylene content: 66%, diene content: 12.5%]

NORDEL (registered trademark) (manufactured by Dow Chemical Company) Series IP 3640 [ethylene content: 55%, diene content: 1.8%], IP 3720P [ethylene content: 70%, diene content: 0.6%], IP 3722P [ethylene content: 71%, diene content: 0.5%], IP 3745P [ethylene content: 70%, diene content: 0.5%], IP 3760P [ethylene content: 67% diene content: 2.2%], IP 4640 [ethylene content: 55%, diene content: 4.9%], IP 4725P [ethylene content: 70%, diene content: 4.9%], IP 4760P [ethylene content: 67% diene content: 4.9%], IP 4770R [ethylene content: 70%, diene content: 4.9%], IP 4770P [ethylene content: 70%, diene content: 4.9%], IP 4785HM [ethylene content: 68%, diene content: 4.9%], IP 3722P EL [ethylene content: 71%, diene content: 0.5%], IP 3745P EL [ethylene content: 70%, diene content: 0.5%], IP 4770P EL [ethylene content: 70%, diene content: 4.9%], and IP 4770R EL [ethylene content: 70%, diene content: 4.9%]

EP21 [ethylene content: 61%, diene content: 5.8%], EP51 [ethylene content: 67%, diene content: 5.8%], EP25 [ethylene content: 58.5%, diene content: 5.1%], EP123 [ethylene content: 58%, diene content: 4.5%], EP103AF [ethylene content: 59%, diene content: 4.5%], EP107F [ethylene content: 62%, diene content: 4.5%], EP57F/C [ethylene content: 67%, diene content: 4.5%], and EP93 [ethylene content: 55%, diene content: 2.7%] which are manufactured by JSR Corporation

Mitsui EPT (manufactured by Mitsui Chemicals, Inc.) Series 1045 [ethylene content: 58%, diene content: 5.0%], 1070 [ethylene content: 57%, diene content: 4.0%], 2060M [ethylene content: 55%, diene content: 2.3%], 3045 [ethylene content: 56%, diene content: 4.7%], 3070 [ethylene content: 58%, diene content: 4.7%], 3091 [ethylene content: 61%, diene content: 5.4%], 3092M [ethylene content: 65%, diene content: 4.6%], 3110M [ethylene content: 56%, diene content: 5.0%], 4070 [ethylene content: 56%, diene content: 8.1%], X-3012P [ethylene content: 72%, diene content: 3.6%], and 3092PM [ethylene content: 65%, diene content: 4.6%]

A proportion of the non-oil extended EPDM is preferably 20 parts by mass or more and preferably 80 parts by mass or less with respect to 100 parts by mass of the total amount of the rubber.

When a proportion of the non-oil extended EPDM is less than this range, the aforementioned high tensile strength may not be imparted to the roller main body in some cases.

On the other hand, when a proportion of non-oil extended EPDM exceeds the above range, rubber hardness of the roller main body increases and thus flexibility decreases, and a frictional coefficient with respect to a sheet decreases, and therefore a paper feeding performance of the paper feeding roller may deteriorate in some cases.

On the other hand, by setting a proportion of the non-oil extended EPDM to be within the above-mentioned range, it is possible to impart a high tensile strength to the roller main body while maintaining a favorable paper feeding performance of the paper feeding roller.

(Oil Extended EPDM)

In order to impart flexibility to the roller main body, it is preferable to use an oil extended EPDM together with a non-oil extended EPDM for the EPDMs.

In order to impart flexibility to a roller main body, in general, a process oil is blended with the rubber and kneaded until becoming uniformly mixed.

However, in order to form a roller main body having high flexibility, it is necessary to blend a large amount of process oil into the rubber composition.

In addition, a long kneading time is required to uniformly mix in a large amount of process oil, and thus workability of kneading deteriorates in some cases.

In addition, a large amount of process oil may bleed to an outer peripheral surface of the roller main body, and this is a cause of a deterioration in the paper feeding performance of the paper feeding roller.

On the contrary, a kneading time is shortened by blending in the oil extended EPDM with which an extender oil has become already mixed, and therefore workability of kneading can be improved.

In addition, an appropriate amount of extender oil contained in the oil extended EPDM does not bleed to the outer peripheral surface of the roller main body.

Therefore, it is preferable not to blend in (exclude) a process oil such as paraffin oil, and even when such an oil has been blended in, it is preferable to set a content of the oil to about 2 parts by mass or less with respect to 100 parts by mass of the total amount of rubber content.

As the oil extended EPDM, it is possible to use various oil extended EPDMs obtained by extending a raw material EPDM by an arbitrary proportion using any extension oil.

However, as the raw material EPDM, which is a base of the oil extended EPDM, it is preferable to select and use an EPDM in which an ethylene content is 55% or more and 72% or less in order to maintain the effects of limiting an ethylene content of the non-oil extended EPDM as described above.

Examples of the extender oil include a paraffin oil and the like.

An oil extended amount of the extender oil is not particularly limited, and is preferably 70 parts by mass (70 phr) or more, and preferably 150 parts by mass (150 phr) or less per 100 parts by mass of EPDMs.

An oil extended EPDM that satisfies these conditions is not limited thereto, and for example, it is possible to use one or two or more of the various oil extended EPDMs described below.

ESPRENE (manufactured by Sumitomo Chemical Co., Ltd.) Series 6101 [ethylene content: 70%, diene content: 6.5%, oil extended amount: 70 phr], 601F [ethylene content: 59%, diene content: 3.5%, oil extended amount: 70 phr], 600F [ethylene content: 66%, diene content: 4.0%, oil extended amount: 100 phr], and 670F [ethylene content: 66%, diene content: 4.0%, oil extended amount: 100 phr]

EP98 [ethylene content: 66%, diene content: 4.5%, oil extended amount: 75 phr] manufactured by JSR Corporation Mitsui EPT X-3042E [ethylene content: 66%, diene content: 4.7%, oil extended amount: 120 phr] manufactured by Mitsui Chemicals, Inc.

In the present disclosure, regarding an oil extended rubber such as an oil extended EPDM, an amount of solid contents (rubber content) in the oil extended rubber is defined as an amount of rubber, thereby obtaining a total amount of rubber, which is a reference for a proportion of each component, and a proportion of each component of rubbers and components other than rubbers.

A proportion of the oil extended EPDM in which an amount of solid contents (EPDM as rubber content) contained in the oil extended EPDM is defined as an amount of rubber, is preferably 10 parts by mass or more and preferably 80 parts by mass or less with respect to 100 parts by mass of the total amount of the rubber.

In a case where a proportion of the oil extended EPDM is less than this range, there is a case in which effects of imparting a favorable paper feeding performance to the paper feeding roller by increasing flexibility of the roller main body, cannot be obtained.

On the other hand, in a case where a proportion of the oil extended EPDM exceeds the above-mentioned range, a proportion of the non-oil extended EPDM relatively decreases, and therefore the aforementioned high tensile strength may not be imparted to the roller main body in some cases.

On the other hand, by setting a proportion of the oil extended EPDM to be within the above-mentioned range, it is possible to impart a high tensile strength to the roller main body while maintaining a favorable paper feeding performance of the paper feeding roller.

In consideration of further improving these effects, a proportion of the oil extended EPDM is preferably 50 parts by mass or more and preferably 70 parts by mass or less in the above-mentioned range.

(Other Rubbers)

As the rubber, other rubbers may be used in combination as long as the effect of the present disclosure is not impaired.

As other rubbers, it is possible to use one or two or more kinds of, for example, natural rubbers, an isoprene rubber (IR), a butadiene rubber (BR), a styrene butadiene rubber (SBR), an acrylonitrile butadiene rubber (NBR), a fluororubber (FKM), a chloroprene rubber (CR), a silicone rubber (VMQ), and the like.

As other rubbers, any of a non-oil extended rubber or an oil extended rubber may be used.

IR which functions to increase a frictional coefficient of a roller main body made of EPDMs with respect to paper to improve the paper feeding performance of the paper feeding roller, is particularly preferable.

As IR, any of various polymers having a polyisoprene structure can be used.

Examples of IR include, but are not limited to, at least one of Nipol (registered trademark) IR2200, IR2200R, and the like manufactured by Zeon Corporation.

In a case where IR is used alone as another rubber (including a case where two or more IRs are used in combination), a proportion of the IR is preferably 10 parts by mass or more, particularly preferably 20 parts by mass or more, and is preferably 60 parts by mass or less, particularly preferably 50 parts by mass or less with respect to 100 parts by mass of the total amount of the rubber.

In a case where a proportion of IR is less than this range, effects of improving the paper feeding performance of the paper feeding roller by increasing a frictional coefficient of the roller main body made of EPDMs with respect to paper and by blending in the IR, are not sufficiently exhibited in some cases.

On the other hand, in a case where a proportion of IR exceeds the above-mentioned range, a proportion of EPDMs relatively decreases, and therefore ozone resistance and weather fastness of the roller main body deteriorate in some cases.

On the other hand, by setting a proportion of IR within the above-mentioned range, it is possible to further improve the paper feeding performance of the paper feeding roller by increasing a frictional coefficient of the roller main body with respect to paper while inhibiting a deterioration in the ozone resistance and weather fastness of the roller main body.

A remaining amount of rubber is non-oil extended EPDMs and oil extended EPDMs.

That is, a total proportion of non-oil extended EPDMs and oil extended EPDMs is preferably 40 parts by mass or more, particularly preferably 50 parts by mass or more, and preferably 90 parts by mass or less, particularly preferably 80 parts by mass or less with respect to 100 parts by mass of the total amount of rubber.

A proportion of other rubbers such as IR is a proportion of non-oil extended rubbers in the case where the other rubbers are non-oil extended rubbers, and a proportion of other rubbers is a proportion of the rubber content as solid contents, which is contained in oil extended rubbers, in the case of oil extended rubbers as described above.

The rubber may be a rubber in which rubbers other than IR are not contained, and the total amount of rubber is that of non-oil extended EPDMs and oil extended EPDMs, that is, a total proportion of non-oil extended EPDMs and oil extended EPDMs which is 100 parts by mass.

However, in this case, a proportion of non-oil extended EPDMs is preferably 80 parts by mass or less.

<Filler>

The reason why a proportion (total amount) of the filler containing at least an amorphous silica is limited to more than 20 parts by mass and 30 parts by mass or less per 100 parts by mass of the total amount of the rubber is as follows.

That is, when a total amount of the filler is less than this range, functions of the filler including an amorphous silica, as a bulking agent and reinforcing agent may not be able to be sufficiently obtained, and therefore it may not be possible to impart a high tensile strength to a roller main body so as to be used for equipment that allows paper to pass through at high speed as described above.

On the other hand, when the total amount of the filler exceeds the above-mentioned range, a viscosity of the rubber composition before crosslinking at the time of heating and melting increases, and therefore workability of the rubber composition deteriorates.

In addition, there is a problem that it is difficult to prepare the rubber composition by blending in each of the above-mentioned components, or to produce the roller main body by molding the prepared rubber composition into, for example, a cylindrical shape.

In addition, abrasion resistance of the roller main body also decreases.

On the other hand, by setting the total amount of the filler to be within the above-mentioned range, it is possible impart favorable abrasion resistance and a high tensile strength to the roller main body while maintaining favorable workability of the rubber composition.

In consideration of further improving such effects, the total amount of the filler is preferably 21 parts by mass or more and preferably 23 parts by mass or more per 100 parts by mass of the total amount of the rubber, in the above-mentioned range.

(Amorphous Silica)

At least an amorphous silica is used as the filler.

By selecting and using an amorphous silica exhibiting a high reinforcing effect as a reinforcing agent for rubber, it is possible to impart a high tensile strength to a roller main body so as to be used for equipment that allows paper to pass through at high speed as described above.

As the amorphous silica, any of wet-type process silicas or dry-type process silicas classified according to a manufacturing method therefore can be used, and an amorphous silica subjected to hydrophobic treatment or the like can also be used.

The amorphous silica is not limited to the following examples, and for example, it is possible to use one or two or more of various amorphous silicas including the Nipsil (registered trademark) Series manufactured by Tosoh Silica Corporation; various amorphous silicas of AEROSIL (registered trademark) Series manufactured by Nippon Aerosil Co., Ltd; and the like.

The reason why a proportion of the amorphous silica is limited to 15 parts by mass or more and 30 parts by mass or less with respect to 100 parts by mass of the total amount of rubber is as follows.

That is, when a proportion of the amorphous silica is less than this range, effects obtainable by blending in the amorphous silica cannot be obtained, and therefore it may not be possible to impart the aforementioned high tensile strength to the roller main body.

On the other hand, when a proportion of the amorphous silica exceeds the above-mentioned range, a viscosity of the rubber composition before crosslinking at the time of heating and melting increases, and therefore workability of the rubber composition deteriorates.

In addition, there is a problem that it is difficult to prepare the rubber composition by blending in each of the above-mentioned components, or to produce the roller main body by molding the prepared rubber composition into, for example, a cylindrical shape.

In addition, abrasion resistance of the roller main body also decreases.

On the other hand, by setting a proportion of the amorphous silica to be within the above-mentioned range, it is possible impart favorable abrasion resistance and a high tensile strength to the roller main body while maintaining favorable workability of the rubber composition.

(Other Fillers)

As the filler, the amorphous silica may be used alone (including a case of using two or more kinds of the amorphous silica in combination), or a filler other than the amorphous silica may be used in combination.

As other fillers, for example, one or two or more fillers such as carbon black, calcium carbonate, zinc oxide, silica compounds other than amorphous silica, clay, talc, magnesium carbonate, aluminum hydroxide, and titanium oxide can be used.

When other fillers are used in combination, a proportion thereof is a remaining amount of the amorphous silica.

In other words, a proportion of another filler may be set such that the total amount of the filler falls within the aforementioned range by setting a proportion of the amorphous silica to a predetermined value within the aforementioned range, and adding the other filler.

A specific proportion of the other filler is not limited thereto, and is preferably, for example, 15 parts by mass or less per 100 parts by mass of the total amount of the rubber.

A lower limit of a proportion of other fillers is 0 parts by mass, which means that a case where other fillers are not used in combination is included.

<Peroxide Crosslinking Agent>

The peroxide crosslinking agent is not limited to the following examples. It is possible to use, for example, one of two or more of benzoyl peroxide, 1,1-bis(tert-butylperoxy)-3,3,5-trimethylcyclohexane, 2,5-dimethyl-2,5-di(benzoylperoxy)hexane, di(tert-butylperoxy)diisopropylbenzene, 1,4-bis[(tertbutyl)peroxyisopropyl]benzene, di(tert-butylperoxy) benzoate, tert-butyl peroxybenzoate, dicumyl peroxide, tert-butyl cumyl peroxide, 2,5-dimethyl-2,5-di(tert-butylperoxy)hexane, di-tert-butyl peroxide, 2,5-dimethyl-2,5-di(tert-butylperoxy)-3-hexene, and the like.

The reason that a proportion of the peroxide crosslinking agent is limited to 2.5 parts by mass or more per 100 parts by mass of the total amount of rubber is because when a proportion of the peroxide crosslinking agent is less than this range, abrasion resistance of the roller main body deteriorates.

On the other hand, by setting a proportion of the peroxide crosslinking agent within the above-mentioned range, abrasion resistance of the roller main body can be improved.

In consideration of further improving such effects, a proportion of the peroxide crosslinking agent is preferably 2.6 parts by mass or more per 100 parts by mass of the total amount of the rubber, in the above-mentioned range.

In addition, a proportion of the peroxide crosslinking agent is preferably 5 parts by mass or less, particularly preferably 4 parts by mass or less per 100 parts by mass of the total amount of the rubber, in the above-mentioned range.

In a case where a proportion of the peroxide crosslinking agent exceeds this range, the rubber composition scorches at the time of molding, flexibility of the roller main body deteriorates, and therefore it may not be possible to form the paper feeding roller that has a favorable paper feeding performance in some cases.

On the other hand, by setting a proportion of the peroxide crosslinking agent to be within the above-mentioned range, flexibility of the roller main body is improved while inhibiting scorching of the rubber composition, and therefore it is possible to form the paper feeding roller that has a favorable paper feeding performance.

<Polyethylene Glycols>

As described in Patent Document 1 and 2, the amorphous silica inhibits crosslinking of the EPDMs by the peroxide crosslinking agent in some cases.

For this reason, it may not be possible to form the roller main body having sufficient mechanical strength in some cases.

In order to prevent this case and to favorably crosslink the EPDMs, the rubber composition may be blended with polyethylene glycols, which function to mask the —OH groups on the surface of the amorphous silica and suppress crosslinking inhibition.

As polyethylene glycols, various polyethylene glycols having an arbitrary average molecular weight can be used.

A proportion of polyethylene glycols is preferably 1% or more, and preferably 4% or less with respect to the total amount of the filler.

When a proportion of polyethylene glycols is less than this range, effects obtainable by blending in the polyethylene glycols cannot be obtained, and therefore crosslinking of EPDMs is inhibited, and the roller main body having sufficient mechanical strength may not be formed in some cases.

On the other hand, when a proportion of polyethylene glycols exceeds the above-mentioned range, excess polyethylene glycols bleed to an outer peripheral surface of the roller main body, a frictional coefficient of the roller main body with respect to a sheet is lowered, and therefore a paper feeding performance of the paper feeding roller deteriorates in some cases.

On the other hand, by setting a proportion of polyethylene glycols to be within the above-mentioned range, inhibition of crosslinking of the EPDMs is suppressed while suppressing a deterioration in a paper feeding performance due to bleeding, and therefore it is possible to form the roller main body having sufficient mechanical strength.

<Other Components>

Components to be generally blended into the rubber composition, such as an antioxidant, a co-crosslinking agent, a pigment, a plasticizer, and a processing aid, may be added to the rubber composition, at an appropriate amount not impairing the effects of the present disclosure.

<<Paper Feeding Roller>>

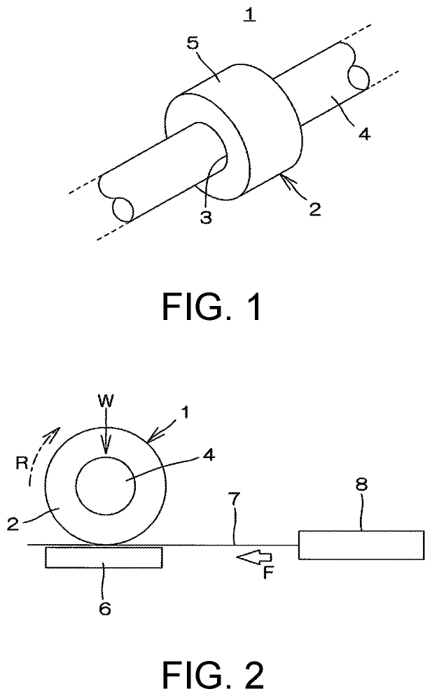

FIG. 1 is a perspective view showing the paper feeding roller of the present disclosure, which is an example of an embodiment.

Referring to FIG. 1, a paper feeding roller 1 of this example includes a roller main body 2 formed by molding the above-described rubber composition of the present disclosure into a tubular shape and crosslinking.

A through hole 3 having a circular cross-section is provided at the center of the roller main body 2, and a shaft 4 having a columnar shape, which is linked to a driving system (not shown), is inserted into the through hole 3 so as to be fixed.

An outer peripheral surface 5 of the roller main body 2, which comes in contact with a sheet, is formed in a cylindrical shape concentric with the through hole 3 and the shaft 4 in the example of the drawing.

The roller main body 2 and the shaft 4 are fixed to each other by, for example, press-fitting the shaft 4 having a larger outer diameter than an inner diameter of the through hole 3 into the through hole 3 of the roller main body 2 so that idling does not occur.

In other words, due to an interference based on a difference in diameter between the roller main body 2 and the shaft 4, a certain idle torque (limit torque which does not cause idling) is secured therebetween.

The shaft 4 is made of, for example, metal, ceramic, hard resin, or the like.

A plurality of roller main bodies 2 may be fixed to a plurality of locations on one shaft 4, if necessary.

The roller main body 2 is manufactured by, for example, molding the rubber composition into a tubular shape by extrusion molding or the like, and then crosslinking by a press crosslinking method or the like; or by molding the rubber composition into a tubular shape by a transfer molding method or the like and crosslinking at the same time.

If necessary, the outer peripheral surface 5 of the roller main body 2 may be polished so as to have a predetermined surface roughness, or may be subjected to knurl processing, surface texturing, or the like at any point in the manufacturing process.

Alternatively, both ends of the roller main body 2 may be cut so that the outer peripheral surface 5 has a predetermined width.

The outer peripheral surface 5 of the roller main body 2 may be coated with any coating layer.

Alternatively, the roller main body 2 may be formed to have a two-layer structure of an outer layer on the outer peripheral surface 5 side and an inner layer on the through hole 3 side.

In this case, at least the outer layer is preferably formed of the rubber composition of the present disclosure.

However, when considering simplifying the structure, improving productivity, lowering manufacturing costs, and the like, it is preferable that the roller main body 2 have a single-layer structure as shown in FIG. 1.

In addition, the roller main body 2 may have a porous structure.

However, in order that concavities due to deformation become unlikely to occur due to improving a tensile strength, improving abrasion resistance, and reducing compression even if a state of contact at one point continues for a relatively long period of time, the roller main body 2 preferably has a substantially nonporous structure.

As described above, in a case where the paper feeding roller 1 is used for equipment such as a high-speed image scanner, which allows a sheet to pass through at a high speed of a sheet passing speed of 200 sheets/minute or more, it is required that the roller main body 2 does not break during use.

For this reason, a tensile strength TS of the roller main body 2, which is measured by a measurement method described in Japan Industrial Standard JIS K 6251: 2010 “Method for obtaining tensile properties of vulcanized rubber and thermoplastic rubber,” is preferably 10 MPa or more.

A tensile strength TS of the roller main body 2 is preferably 13 MPa or less in the above-mentioned range.

In order to form the roller main body 2 having a tensile strength TS exceeding this range, a large amount exceeding 30 parts by mass of the filler containing the amorphous silica needs to be blended in per 100 parts by mass of the total amount of rubber.

Accordingly, workability of the rubber composition may deteriorate, and abrasion resistance of the roller main body 2 may deteriorate in some cases.

In addition, it is preferable that the roller main body 2 have a type A durometer hardness of less than 60 for favorable paper feeding.

Furthermore, when considering improvement in abrasion resistance and reduction in compression, the roller main body 2 preferably has a type A durometer hardness of 20 or more, particularly preferably 40 or more.

Depending on the application of the paper feeding roller 1, the through hole 3 may be provided at a position eccentric from the center of the roller main body 2.

In addition, the outer peripheral surface 5 of the roller main body 2 may have not only a tubular shape, but also an irregular shape, for example, a shape in which a part of the tubular outer peripheral surface is cut out into a planar shape.

In order to manufacture the paper feeding roller 1 including the roller main body 2 with these irregular shapes, the roller main body 2 having an irregular shape may be directly formed by the above-described manufacturing method and then crosslinked, or the roller main body 2 formed into a tubular shape may be made to have an irregular shape by post-processing.

In addition, the roller main body 2 may be deformed into an irregular shape by press-fitting the shaft 4 which has been made to have a deformed shape corresponding to an irregular shape of the roller main body 2, into the through hole 3 of the roller main body 2 formed into a tubular shape.

In this case, polishing, knurl processing, surface texturing, and the like of the outer peripheral surface 5 can be performed on the tubular outer peripheral surface 5 before deformation, and therefore workability can be improved.

<<Image Forming Apparatus>>

The paper feeding roller of the present disclosure can be incorporated into various image forming apparatuses which use electrophotography, such as laser printers, electrostatic copying machines, plain paper facsimile machines, or multifunction machines thereof.

Furthermore, the paper feeding roller of the present disclosure can also be incorporated into, for example, an image scanner, an ink jet printer, an ATM, or the like.

In particular, the roller main body of the paper feeding roller of the present disclosure has a high tensile strength, and thus can be suitability used by being incorporated into, for example, equipment such as a high-speed image scanner, which allows a sheet to pass through at a high speed of a sheet passing speed of 200 sheets/minute or more.

The paper feeding roller of the present disclosure can be used as, for example, a paper supply roller, a carrying roller, a platen roller, a paper discharging roller, or the like, which are incorporated into such equipment, and rotate while coming into contact with paper to carry the paper by friction.

In the paper feeding roller of the present disclosure, flexibility of the roller main body is excellent, and therefore a favorable paper feeding performance can be exhibited when being used as various rollers.

Furthermore, in the paper feeding roller of the present disclosure, abrasion resistance of the roller main body is excellent, and a tensile strength also high, and therefore breakage does not occur during use even when the paper feeding roller is used by being incorporated into the above-mentioned equipment such as a high-speed image scanner.

Therefore, it is possible to extend the life of the roller to more than that in present circumstances to reduce a frequency of replacement, and to realize the high durability required for various equipment.

### EXAMPLES

Hereinafter, the present disclosure will be further explained based on examples and comparative examples, but the constitution of the present disclosure is not limited by these examples.

### Example 1

(Preparation of Rubber Composition)

As a rubber, 50 parts by mass of the non-oil extended EPDM [ESPRENE 586 manufactured by Sumitomo Chemical Co., Ltd., ethylene content: 66%, diene content: 12.5%] and 100 parts by mass of the oil extended EPDM [ESPRENE 670F manufactured by Sumitomo Chemical Co., Ltd., ethylene content: 66%, diene content: 4.0%, oil extended amount: 100 phr] (solid contents: 50 parts by mass) were used.

A total of 28.2 parts by mass of 25 parts by mass of amorphous silica [Nipsil VN3 manufactured by Tosoh Silica Corporation, wet-type process silica], 0.2 parts by mass of carbon black [HAF, trade name SEAST 3, manufactured by Tokai Carbon Co., Ltd.], and 3 parts by mass of zinc oxide [manufactured by Shiraishi Calcium Kaisha, Ltd.] as a filler; 0.7 parts by mass of polyethylene glycol (#4000); and 2.7 parts by mass of dicumyl peroxide [percumyl (registered trademark) D manufactured by NOF CORPORATION] as a peroxide crosslinking agent were blended into a total amount of 150 parts by mass of both rubbers (total amount of rubber as solid contents was 100 parts by mass), and kneaded using a 3 L kneader and an open roller, and therefore a rubber composition was prepared.

### Example 2

A rubber composition was prepared in the same manner as in Example 1 except that an amount of the non-oil extended EPDM was 30 parts by mass, an amount of the oil extended EPDM was 140 parts by mass (solid contents: 70 parts by mass), an amount of the amorphous silica was 20 parts by mass, an amount of the polyethylene glycol was 0.5 parts by mass, and an amount of the peroxide crosslinking agent was 3 parts by mass.

A total amount of the filler was 23.2 parts by mass.

### Example 3

A rubber composition was prepared in the same manner as in Example 1 except that an amount of the non-oil extended EPDM was 30 parts by mass, an amount of the oil extended EPDM was 140 parts by mass (solid contents: 70 parts by mass), an amount of the amorphous silica was 15 parts by mass, an amount of the polyethylene glycol was 1 part by mass, and an amount of the peroxide crosslinking agent was 3 parts by mass; and that 10 parts by mass of clay [classified hard clay product, ST-CROWN manufactured by Shiraishi Calcium Kaisha, Ltd.] was blended in as a filler.

A total amount of the filler was 28.2 parts by mass.

### Comparative Example 1

A rubber composition was prepared in the same manner as in Example 1 except that an amount of the non-oil extended EPDM was 75 parts by mass, an amount of the oil extended EPDM was 50 parts by mass (solid contents: 25 parts by mass), an amount of the amorphous silica was 5 parts by mass, and an amount of the polyethylene glycol was 0.1 parts by mass.

A total amount of the filler was 8.2 parts by mass.

### Comparative Example 2

A rubber composition was prepared in the same manner as in Example 1 except that 70 parts by mass of clay [classified hard clay product, ST-CROWN manufactured by Shiraishi Calcium Kaisha, Ltd.] was blended in as a filler instead of blending in the amorphous silica, and that an amount of polyethylene glycol was 2.1 parts by mass.

A total amount of the filler was 73.2 parts by mass.

### Comparative Example 3

A rubber composition was prepared in the same manner as in Example 1 except that an amount of amorphous silica was 15 parts by mass, and an amount of polyethylene glycol was 1.5 parts by mass; and that 40 parts by mass of talc [Mistron (registered trademark) vapor manufactured by Imerys Specialities Japan Co., Ltd.] was blended in as a filler.

A total amount of the filler was 58.2 parts by mass.

### Comparative Example 4

A rubber composition was prepared in the same manner as in Example 1 except that an amount of the peroxide crosslinking agent was 2 parts by mass.

A total amount of the filler was 28.2 parts by mass.

<Hardness Test>

The rubber compositions prepared in Examples 1 to 3 and Comparative Examples 1 to 4 were press-crosslinked under the conditions of 170° C. for 20 minutes to form sheets having a thickness of 2 mm, and three sheets thereof were laminated to prepare test pieces.

Using these test pieces, numerical values after 3 seconds were read under the environment of a temperature at 23±2° C. in accordance with a measurement method described in Japan Industrial Standard JIS K 6253-3: 2012 “Method for obtaining hardness of vulcanized rubber and thermoplastic rubber—Part 3: Durometer hardness,” and these values were used as a type A durometer hardness.

<Tensile Test>

The rubber compositions prepared in Examples 1 to 3 and Comparative Examples 1 to 4 were press-crosslinked under the conditions of 170° C. for 20 minutes to form sheets having a thickness of 2 mm, and were punched so as to produce a dumbbell-shaped No. 3 test piece defined in the aforementioned JIS K 6251: 2010.

Next, using the produced test piece, a tensile test was carried out in accordance with a test method described in the above-mentioned standard under an environment of a temperature at 23±2° C., and therefore a tensile strength TS (MPa) and an elongation at break Eb (%) were obtained.

Then, a test piece in which a tensile strength TS was 10 MPa or more was evaluated as good, “0,” and a test piece in which a tensile strength TS was less than 10 MPa was evaluated as poor, “X.”

<Production of Paper feeding Roller>

The rubber compositions prepared in Examples 1 to 3 and Comparative Examples 1 to 4 were transfer-molded into a tubular shape under conditions of 170° C. for 20 minutes, and while being in a state where the shaft 4 with an outer diameter of 17 mm was pressed into the through hole 3, the transfer-molded rubber compositions were polished so as to have an outer diameter of 23 mm by using a cylindrical grinding machine, and then cut to have a width of 30 mm, and therefore a paper feeding roller 1 having a tubular roller main body 2 was produced.

<Frictional Coefficient Test>

As shown in FIG. 2, the roller main body 2 of the produced paper feeding roller 1 was pressed, while applying a vertical load W (=300 gf), on a paper 7 having a width of 60 mm and a length of 210 mm [P paper (plain paper) manufactured by Fuji Xerox Co., Ltd.] placed on a plate 6 made of polytetrafluoroethylene (PTFE) which was horizontally installed.

Next, a carrying force F (gf) applied to a load cell 8 in contact with one end of the paper 7 was measured when the roller main body 2 was rotated at 200 rpm in a direction indicated by a single dot-dashed line arrow R in an environment of a temperature of 23±2° C. and a relative humidity of 55±10%.

Next, a frictional coefficient μ was obtained from the measured carrying force F and the vertical load W (=300 gf) by Formula (1):

μ=F (gf)/W (gf) (1)

Then, a test piece in which a frictional coefficient μ was 1.5 or more was evaluated as good, “O,” and a test piece in which a frictional coefficient μ was less than 1.5 was evaluated as poor, “X.”

<Abrasion Resistance Test>

In the same manner as in the above-described frictional coefficient test, as shown in FIG. 2, the roller main body 2 of the produced paper feeding roller 1 was pressed, while applying a vertical load W (=500 gf), on the paper 7 having a width of 60 mm and a length of 210 mm [P paper (plain paper) manufactured by Fuji Xerox Co., Ltd.] placed on the plate 6 made of polytetrafluoroethylene (PTFE) which was horizontally installed.

Next, the roller main body 2 was continuously rotated at 200 rpm for 10 minutes in the direction indicated by the single dot-dashed line arrow R in an environment of a temperature of 23±2° C. and a relative humidity of 55±10%.

Next, a mass of the roller main body (mass after abrasion) was weighed after continuous rotation, and an abrasion rate was obtained from a mass (g) after abrasion and an initial mass (g) of the roller main body weighed before continuous rotation by Formula (2):

Abrasion rate (%)=(initial mass−mass after abrasion)/(initial mass)×100 (2)

Then, a test piece in which an abrasion rate was 1% or less was evaluated as good, “0,” and a test piece in which an abrasion rate was more than 1% was evaluated as poor, “X.”

The above results are shown in Table 1 and Table 2.

TABLE 1

| | | | Example 1 | Example 2 | Example 3 |
|---|---|---|---|---|---|
| Components | Non-oil extended | Ethylene content | 66 | 66 | 66 |
| | EPDM | (%) | | | |
| | | Parts by mass | 50 | 30 | 30 |
| | Oil extended EPDM | | 100 | 140 | 140 |
| | (parts by mass) | | [50] | [70] | [70] |
| | [solid content (parts by mass)] | | | | |
| | Filler | Amorphous silica | 25 | 20 | 15 |
| | (parts by mass) | Carbon black | 0.2 | 0.2 | 0.2 |
| | | Zinc oxide | 3 | 3 | 3 |
| | | Clay | — | — | 10 |
| | | Talc | — | — | — |
| | | Total | 28.2 | 23.2 | 28.2 |
| | Polyethylene glycol | | 0.7 | 0.5 | 1 |
| | Peroxide crosslinking agent (parts by | | 2.7 | 3 | 3 |
| | mass) | | | | |
| Test | Type A durometer hardness | | 54 | 44 | 40 |
| | Tensile test | TS (MPa) | 12.4 | 11.5 | 10.6 |
| | | E_{b} (%) | 640 | 830 | 720 |
| | | Evaluation | ◯ | ◯ | ◯ |
| | Frictional | Numerical value | 1.72 | 1.92 | 1.92 |
| | coefficient μ | Evaluation | ◯ | ◯ | ◯ |
| | Abrasion resistance | Abrasion rate (%) | 0.33 | 0.65 | 0.82 |
| | | Evaluation | ◯ | ◯ | ◯ |

TABLE 2

| | | | Comparative | Comparative | Comparative | Comparative |
|---|---|---|---|---|---|---|
| | | | Example 1 | Example 2 | Example 3 | Example 4 |
| Components | Non-oil | Ethylene | 66 | 66 | 66 | 66 |
| | extended | content (%) | | | | |
| | EPDM | Parts by mass | 75 | 50 | 50 | 50 |
| | Oil extended EPDM | | 50 | 100 | 100 | 100 |
| | (parts by mass) | | [25] | [50] | [50] | [50] |
| | [solid content (parts by mass)] | | | | | |
| | Filler | Amorphous | 5 | — | 15 | 25 |
| | (parts by mass) | silica | | | | |
| | | Carbon black | 0.2 | 0.2 | 0.2 | 0.2 |
| | | Zinc oxide | 3 | 3 | 3 | 3 |
| | | Clay | — | 70 | — | — |
| | | Talc | — | — | 40 | — |
| | | Total | 8.2 | 73.2 | 58.2 | 28.2 |
| | Polyethylene glycol | | 0.1 | 2.1 | 1.5 | 0.7 |
| | Peroxide crosslinking agent | | 2.7 | 2.7 | 3 | 2 |
| | (parts by mass) | | | | | |
| Test | Type A durometer hardness | | 50 | 51 | 54 | 52 |
| | Tensile test | TS (MPa) | 5.8 | 11.3 | 13.8 | 12.7 |
| | | E_{b} (%) | 500 | 675 | 610 | 750 |
| | | Evaluation | X | O | O | O |
| | Frictional | Numerical value | 1.71 | 1.75 | 1.59 | 1.73 |
| | coefficient μ | Evaluation | O | O | O | O |
| | Abrasion | Abrasion rate | 0.11 | 1.39 | 1.22 | 1.02 |
| | resistance | (%) | | | | |
| | | Evaluation | O | X | X | X |

Based on the results of Examples 1 to 3 and Comparative Examples 1 to 4 of Table 1 and Table 2, it was found that, by forming the roller main body using a rubber composition containing: a rubber that contains the non-oil extended EPDM having an ethylene content of 55 to 72%; more than 20 parts by mass and 30 parts by mass or less of a filler per 100 parts by mass of the rubber; and 2.5 parts by mass or more of a peroxide crosslinking agent, in which the filler contains 15 to 30 parts by mass of an amorphous silica per 100 parts by mass of the rubber, it is possible to impart a high tensile strength to the roller main body so as to be able to be used specifically for equipment that allows paper to pass through at high speed, while maintaining high abrasion resistance of the roller main body and a favorable paper feeding performance of the paper feeding roller.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A rubber composition for forming a roller main body of a paper feeding roller, the rubber composition containing:
a rubber that comprises at least an ethylene propylene diene rubber;
more than 20 parts by mass and 30 parts by mass or less of a filler per 100 parts by mass of a total amount of the rubber; and
2.5 parts by mass or more of a peroxide crosslinking agent per 100 parts by mass of the total amount of the rubber,
wherein the ethylene propylene diene rubber contains at least a non-oil extended ethylene propylene diene rubber having an ethylene content of 55% or more and 72% or less, and
the filler contains at least 15 parts by mass or more and 30 parts by mass less of an amorphous silica per 100 parts by mass of the total amount of the rubber.

2. The rubber composition according to claim 1, wherein a proportion of the non-oil extended ethylene propylene diene rubber having an ethylene content of 55% or more and 72% or less is 20 parts by mass or more and 80 parts by mass or less with respect to 100 parts by mass of the total amount of the rubber.

3. The rubber composition according to claim 1, wherein the ethylene propylene diene rubber is a non-oil extended ethylene propylene diene rubber having an ethylene content of 55% or more and 72% or less, and an oil extended ethylene propylene diene rubber.

4. The rubber composition according to claim 1, wherein a proportion of the filler is 23 parts by mass or more per 100 parts by mass of the total amount of the rubber.

5. The rubber composition according to claim 1, wherein a proportion of the peroxide crosslinking agent is 2.6 parts by mass or more and 5 parts by mass or less per 100 parts by mass of the total amount of the rubber.

6. The rubber composition according to claim 1, wherein a proportion of the non-oil extended ethylene propylene diene rubber having an ethylene content of 55% or more and 72% or less is 20 parts by mass or more and 80 parts by mass or less with respect to 100 parts by mass of the total amount of the rubber,
the ethylene propylene diene rubber is a non-oil extended ethylene propylene diene rubber having an ethylene content of 55% or more and 72% or less, and an oil extended ethylene propylene diene rubber.

7. The rubber composition according to claim 1, wherein a proportion of the non-oil extended ethylene propylene diene rubber having an ethylene content of 55% or more and 72% or less is 20 parts by mass or more and 80 parts by mass or less with respect to 100 parts by mass of the total amount of the rubber,
the ethylene propylene diene rubber is a non-oil extended ethylene propylene diene rubber having an ethylene content of 55% or more and 72% or less, and an oil extended ethylene propylene diene rubber,
a proportion of the filler is 23 parts by mass or more per 100 parts by mass of the total amount of the rubber.

8. The rubber composition according to claim 1, wherein a proportion of the non-oil extended ethylene propylene diene rubber having an ethylene content of 55% or more and 72% or less is 20 parts by mass or more and 80 parts by mass or less with respect to 100 parts by mass of the total amount of the rubber,
the ethylene propylene diene rubber is a non-oil extended ethylene propylene diene rubber having an ethylene content of 55% or more and 72% or less, and an oil extended ethylene propylene diene rubber,
a proportion of the peroxide crosslinking agent is 2.6 parts by mass or more and 5 parts by mass or less per 100 parts by mass of the total amount of the rubber.

9. The rubber composition according to claim 1, wherein a proportion of the non-oil extended ethylene propylene diene rubber having an ethylene content of 55% or more and 72% or less is 20 parts by mass or more and 80 parts by mass or less with respect to 100 parts by mass of the total amount of the rubber,
the ethylene propylene diene rubber is a non-oil extended ethylene propylene diene rubber having an ethylene content of 55% or more and 72% or less, and an oil extended ethylene propylene diene rubber,
a proportion of the filler is 23 parts by mass or more per 100 parts by mass of the total amount of the rubber,
a proportion of the peroxide crosslinking agent is 2.6 parts by mass or more and 5 parts by mass or less per 100 parts by mass of the total amount of the rubber.

10. A paper feeding roller comprising a roller main body that is made of the rubber composition according to claim 1.

11. The paper feeding roller according to claim 10, wherein the roller main body has a tensile strength TS of 10 MPa or more as measured by a measurement method described in JIS K 6251: 2010.
